(19) United States
(12) Patent Application Publication
(10) Pub. No.: US 2025/0365524 A1
(43) Pub. Date: Nov. 27, 2025

(54) WIRELESS EARPHONE ADAPTER DEVICE

(71) Applicant: XOOPAR LIMITED, New Territories (HK)

(72) Inventor: Ka Yin Tsui, New Territories (HK)

(21) Appl. No.: 18/823,672

(22) Filed: Sep. 3, 2024

(30) Foreign Application Priority Data
May 23, 2024 (CN) 202421132747.8

(51) Int. Cl. H04R 1/10; H02J 7/00

(52) U.S. Cl. CPC H04R 1/1025; H02J 7/00034; H04R 1/1041; H04R 2420/07

(57) ABSTRACT

The application relates to a wireless earphone adapter device, comprising an adapter component, and the adapter component comprises a control unit, an audio input interface, a wireless communication module, a battery, a power input interface and a power output interface. The audio input interface configured to receive audio signals when an audio equipment is connected. The wireless communication module configured to transmit the audio signals converted into wireless signals to a wireless earphone. The power input interface configured to obtain power from the power adapter and charging the battery. The power output interface configured to transmit a voltage of the power input interface to a charging case of the wireless earphone for power supply. The application can not only realize audio transmission between audio-visual or audio equipment without wireless connection function and the wireless earphone, but also charge the charging case of the wireless earphone.

### CROSS REFERENCE TO RELATED APPLICATIONS

The present application claims the benefit of Chinese Patent Application No. 202421132747.8 filed on May 23, 2024, the contents of which are incorporated herein by reference in their entirety.

### TECHNICAL FIELD

The present disclosure relates to the technical field of wireless earphones, in particular to a wireless earphone adapter device.

### BACKGROUND

Wireless earphones include infrared wireless earphones, meter wave wireless earphones (“FM earphones”), decimeter wave wireless earphones (Bluetooth earphones) and other forms of earphones, which allow users to free from the constraints of wires, and are widely used because of the ease of use.

However, some audio-visual or audio equipment (such as older mobile phones, and some equipment in aircraft, yachts and gyms) without wireless earphone connection function are still in use, making users unable to use wireless earphones in corresponding scenarios.

### SUMMARY

The technical problem to be solved by the application is to provide a wireless earphone adapter device.

The application adopts the following technical solution:

A wireless earphone adapter device is constructed, which comprises an adapter component, and the adapter component comprises:

A control unit.

An audio input interface electrically connected with the control unit and configured to receive audio signals when an audio equipment is connected.

A wireless communication module electrically connected to the control unit and configured to transmit the audio signals converted into wireless signals to a wireless earphone.

A battery electrically connected with the control unit.

A power input interface electrically connected with a power adapter and configured to obtain power from the power adapter and charging the battery. And

A power output interface electrically connected to the power input interface and configured to transmit a voltage of the power input interface to a charging case of the wireless earphone for power supply.

In some embodiments, the device also comprises a housing body, the adapter component is arranged in the housing body and is arranged at the bottom end of the housing body, a receiving space configured to receive the charging case is formed above the adapter component, and the power output interface extends partially into the receiving space.

In some embodiments, the adapter component comprises a plate body, the control unit, the wireless communication module, the power input interface and the power output interface are arranged on the plate body, the power output interface is erected on a face of the plate body close to the receiving space, and the battery is arranged on a side of the plate body away from the receiving space.

In some embodiments, the device also comprises a cover, an opening communicating the receiving space with the outside is formed in the housing body, and the cover is configured to close the opening.

In some embodiments, the opening is located at the top end of the housing body, and the cover is fitted onto a cover body of the charging case.

In some embodiments, a first relief hole configured for the audio input interface to penetrate is formed in the housing body, an outer wall surface of the housing body is recessed inward to form a relief groove for accommodating the audio input interface, and the relief groove is communicated with the first relief hole.

In some embodiments, the adapter component also comprises a trigger module electrically connected with the control unit, and the trigger module is configured to generate a first trigger signal and to transmit the first trigger signal to the control unit when the audio input interface is accommodated in the relief groove, and to generate a second trigger signal and transmit the second trigger signal to the control unit when the audio input interface is located outside the relief groove.

The adapter component also comprises a switch module electrically connected with the control unit and the wireless communication module, and the switch module is configured to control the wireless communication module to switch off when the control unit receives the first trigger signal, and to control the wireless communication module to switch on when the control unit receives the second trigger signal.

In some embodiments, a first switch hole is also formed in a wall defining the relief groove, and the trigger module penetrates into the first switch hole, so as to enable the audio input interface to be abutted against the trigger module when the audio input interface is accommodated in the relief groove.

In some embodiments, the adapter component also comprises an adapter housing, the control unit, the wireless communication module and the battery are arranged in the adapter housing, and the audio input interface, the power input interface and the power output interface penetrate through the adapter housing, respectively.

In some embodiments, the audio input interface comprises a transmission line and a transmission connector arranged on one end of the transmission line, and the other end of the transmission line is electrically connected with the control unit.

The application has at least the following advantages:

By providing the audio input interface and the wireless communication module, the application enables a user group of wireless earphones to connect audio-visual or audio equipment through the audio input interface when facing audio-visual or audio equipment without wireless connection function, and transmit audio signals to the wireless earphones through the wireless communication module electrically connected with the audio input interface, thus to realize audio transmission.

By providing the battery, the present application can ensure that the wireless earphone adapter device can be used independently from an external power supply, and by providing the power input interface and the power output interface, the present application can not only charge and supply power to the battery, but also supply power to the charging case of the wireless earphone.

### DESCRIPTION OF DRAWINGS

To more clearly describe the technical solution of the application, the application will be further described below in combination with drawings and embodiments. It shall be understood that the following drawings only show some embodiments of the application, and thus shall not be regarded as limitations to the scope. For those ordinary skilled in the art, other related drawings can also be obtained according to the drawings without contributing creative labor. Among the drawings:

FIG. 1 is a is a three-dimensional structural schematic diagram of a wireless earphone adapter device in an embodiment of the application.

FIG. 2 is a three-dimensional structural schematic diagram of the wireless earphone adapter device shown in FIG. 1 at another angle.

FIG. 3 is an exploded view of an adapter component in the wireless earphone adapter device shown in FIG. 1.

FIG. 4 is an exploded view of the adapter component shown in FIG. 3 at another angle.

FIG. 5 is a sectional structural schematic diagram of the wireless earphone adapter device shown in FIG. 1 in a use state.

### DETAILED DESCRIPTION

To understand technical features, purpose and effects of the application more clearly, specific embodiments of the application are described in detail with reference to the drawings. It should be understood in the following description that the terms such as “front”, “rear”, “upper”, “lower”, “left”, “right”, “vertical”, “horizontal”, “bottom”, “inner”, “inside” and “outer” indicate direction or position relationships shown based on part of the drawings or constructed and operated in a specific direction, and are only intended to facilitate the description of the technical solution rather than to indicate that the indicated device or element must have a specific direction, and therefore, shall not be understood as a limitation to the application.

It should also be noted that unless otherwise specifically regulated and defined, the terms such as “installation”, “connected”, “connecting”, “fixation”, “arranged” and the like shall be understood in broad sense, and for example, may refer to fixed connection or detachable connection or integral connection, may refer to mechanical connection or electrical connection, and may refer to direct connection or indirect connection through an intermediate medium or inner communication of two elements or interaction relationship of two elements. When an element is known as being “above” or “below” another element, the element can be “directly” or “indirectly” located on another element, or one or more intermediate elements may also exist. The terms such as “first” and “second” are only intended to facilitate the description of the technical solution, and shall not be understood as indicating or implying relative importance or hint the number of indicated technical features; therefore, features defined by “first” or “second” may explicitly or implicitly include one or more such features. For those ordinary skilled in the art, the specific meanings of the above terms in the application may be understood according to concrete conditions.

In the following description, specific details such as specific system structures and techniques are presented for the purpose of illustration rather than limitation in order to fully understand the embodiments of the application. However, those skilled in the art should understand that the application can also be realized in other embodiments without such specific details. In other cases, detailed description of well-known systems, devices, circuits and methods are omitted so as not to hinder the description of the application with unnecessary details.

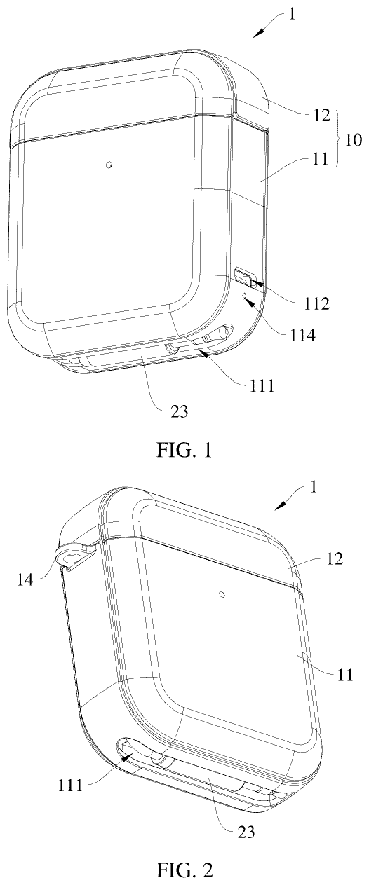

FIG. 1-FIG. 5 show a wireless earphone adapter device 1 in an embodiment of the application, which comprises an adapter component 20. The adapter component 20 comprises a control unit (not shown in the figures), a wireless communication module (not shown in the figures), an audio input interface 23, a battery 24, a power input interface 25 and a power output interface 26. The audio input interface 23 is electrically connected with the control unit and configured to be electrically connected with audio equipment without wireless communication function to receive audio signals. The battery 24 is electrically connected with the control unit and configured to supply power, respectively. The power input interface 25 is electrically connected with a power adapter and configured to obtain power from the power adapter and charging the battery 24. The power output interface 26 is electrically connected to the power input interface 25 and configured to transmit a voltage of the power input interface 25 to a charging case of a wireless earphone to supply power to the charging case of the wireless earphone when the power output interface 26 is electrically connected with charging case of the wireless earphone. The control unit is configured to control the operation of the whole wireless earphone adapter device 1. The wireless communication module is configured to transmit the audio signals converted into wireless signals to the wireless earphone, thus to realize transmission of audio signals between the audio equipment without wireless communication function and the wireless earphone.

By providing the audio input interface 23 and the wireless communication module, the present application enables a user group of wireless earphones to connect audio equipment through the audio input interface 23 when facing audio-visual or audio equipment without wireless connection function, and transmit wireless signals to the wireless earphones through the wireless communication module, thus to realize audio transmission. By providing the battery 24, the power input interface 25 and the power output interface 26, the present application ensures that the wireless earphone adapter device 1 can not only charge and supply power to the battery 24, but also supply power to the charging case.

As shown in FIG. 1 and FIG. 2, in some embodiments, the wireless earphone adapter device 1 comprises a housing 10, and the adapter component 20 is arranged in the housing 10.

Specifically, the housing 10 comprises a housing body 11 and a cover 12. The housing body 11 is open at one end and closed at the other, the adapter component 20 is arranged in the housing body 11 and is arranged at the bottom end of the housing body 11. A receiving space 13 configured to store the charging case is formed above the adapter component 20. The power output interface 26 extends partially into the receiving space 13, so as to realize docking with a charging port of the charging case located in the receiving space 13 for power supply. An opening communicating the receiving space 13 with the outside is formed at the top end of the housing body 11, configured to take out or put back the charging case. The cover 12 is covered on the opening, i.e., the receiving space 13 is defined by the cover 12, the housing body 11 and the adapter component 20 together.

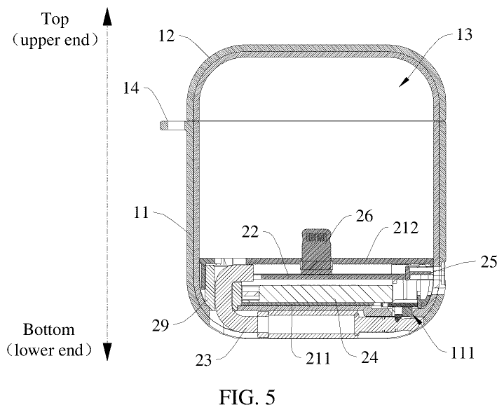

It should be understood that the “bottom” and “above” mentioned refer to the bottom and above at the angle shown in FIG. 5.

In some other optional embodiments, the receiving space 13 may also be formed on a side of the adapter component 20. In this case, when the opening is positioned at the top end of the housing body11, the opening of the housing body 11 may be arranged on one side corresponding to the receiving space 13, or above both the receiving space 13 and the adapter component 20. When the opening is opened, the receiving space 13 and the adapter component 20 are exposed to the external environment.

In the present embodiment, the housing 10 is roughly in a flat cuboidal shape, and the junctions of each face are curved to ensure a good hand feeling. The housing 10 can have a horizontal section thereof is roughly in an oval or racetrack-shaped, and two vertical sections across two axes of the horizontal section can be roughly in a rectangular or racetrack-shaped (oval), respectively. The opening is formed in a top end of housing body 11, the cover 12 is arranged on the top end of housing body 11 and covered on the opening. The outer contour of the cover 12 is adapted to the outer contour of an upper end of the housing body 11, so as to ensure the smoothness of the overall outer contour of the housing 10 composed of the cover 12 and the housing body 11.

In some other optional embodiments, the opening may also be formed in a side end of the housing body 11, or the opening may be formed in a side wall or other positions of the housing body 11.

In some other optional embodiments, the housing 10 may also be in other shapes such as a round cake shape, a polygonal cake shape or an irregular shape, etc.

In some embodiments, the cover 12 is fitted onto a cover body of the charging case, so that when the cover 12 is opened, the charging case can be opened at the same time. The wireless earphone can be taken out directly, which reduces operation steps and improves user experience.

In the present embodiment, “the cover 12 is fitted onto a cover body of the charging case” means that the inner contour of the cover 12 is adapted to the outer contour of the cover body of the charging case, and the cover body of the charging case can be installed in the cover 12 through interference fit.

In some other optional embodiments, “the cover 12 is fitted onto a cover body of the charging case” may also mean that the charging case can be accommodated in the cover 12.

In some embodiments, the cover 12 and the housing body 11 can be arranged separately, arranged in rotatable connection or arranged in detachable connection, which will not be limited specifically herein.

In some other optional embodiments, the cover 12 may also be omitted to make the opening always open. The charging case may be partially exposed or fully accommodated in the receiving space 13.

It is also shown in FIG. 2 that in some embodiments, the housing 10 may also comprise at least one hanging piece 14, the hanging piece 14 is convexly arranged on the outer wall surface of the housing body 11 and configured to be connected with components such as a key ring or a hook. A hanging hole is formed in the hanging piece 14 for realizing connection.

In the present embodiment, the hanging piece 14 is arranged on an outer wall surface of a side wall at the top end of the housing body 11.

In some other optional embodiments, the hanging piece 14 may also be arranged at other positions on the cover 12 or the housing body 11.

In some embodiments, the housing 10 may also comprise at least one support leg (not shown in the figure), the support leg is arranged on the outer wall surface of the housing body 11 and configured to support the housing 10. The wireless earphone adapter device 1 can be erected on a flat surface such as a desktop by the support leg.

Specifically, two support legs are adopted, which are arranged on one end of the housing body 11 away from the cover 12 and are arranged on the same side of the end.

In some other optional embodiments, one, three, four or more support legs may also be adopted, and may also be arranged on two opposite sides of one end of the housing body 11 away from the cover 12, or arranged on other ends (sides) of the housing body 11, or arranged on the cover 12, etc.

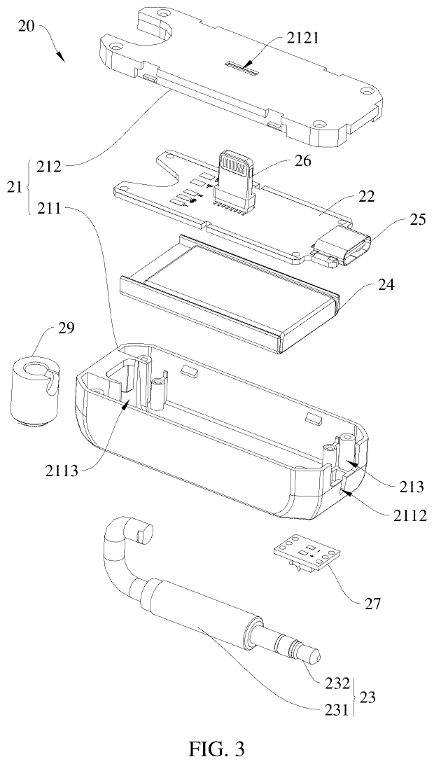

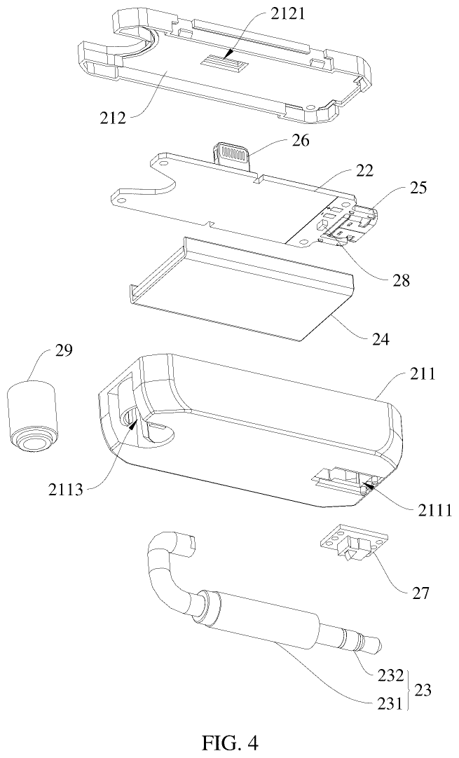

As shown in FIG. 3 and FIG. 4, in some embodiments, the adapter component 20 also comprises a plate body 22, the control unit, the wireless communication module, the power input interface 25 and the power output interface 26 are arranged on the plate body 22. The power output interface 26 is erected on a face of the plate body 22 close to the receiving space 13. The battery 24 is arranged on a side of the plate body 22 away from the receiving space 13.

Upper surface of the plate body 22 is defined as a first surface at the angle shown in FIG. 5, and the lower surface, which is opposite to the upper surface of the plate body 22 is defined as a second surface. The power output interface 26 is erected on the first surface of the plate body 22, and the battery 24 is arranged adjacent to the second surface of the plate body 22. The wireless communication module is also arranged on the first surface.

In the present embodiment, the plate body 22 is arranged lengthwise, the power input interface 25 is arranged on one end of the plate body 22, and the audio input interface 23 is arranged on the other end of the plate body 22 for the convenience of penetrating out from the housing 10.

Correspondingly, a first charging hole 112 is formed in the housing body 11 and used for the power input interface 25 to penetrate. A first relief hole (not shown in the figure) is formed in the housing body 11 and used for the audio input interface 23 to penetrate out and realize electrical connection with audio equipment without wireless connection function.

In some other optional embodiments, the power input interface 25 and/or the audio input interface 23 may also be arranged at other positions on the plate body 22, and the two can also be arranged at the same end, etc.

In some embodiments, the audio input interface 23 comprises a transmission connector 232 and is configured to be connected with audio-visual or audio equipment without wireless connection function to realize audio transmission.

In the present embodiment, the transmission connector 232 is a 3.5 mm audio connector.

In some other optional embodiments, the transmission connector 232 may also be an audio connector of other sizes.

In some embodiments, the audio input interface 23 may also comprise a transmission line 231, so that the physical connection distance of the audio input interface 23 can be increased. The situation of being unable to connect can be avoided by the extended transmission line 231 in case that the audio input interface 23 is difficult to be plugged directly into equipment.

In the present embodiment, the transmission line 231 penetrates into the first relief hole, one end of the transmission line 231 is fixed on one end of the plate body 22 and is electrically connected with the control unit, and the other end is connected with the transmission connector 232. Transmission connector 232 is located outside the housing body 11.

In some other optional embodiments, the transmission line 231 may also have no fixation relationship with the plate body 22, but is only electrically connected with the control unit by a cable, etc.

It is also shown in FIG. 1 and FIG. 2 that in some embodiments, a relief groove 111 configured to accommodate at least part of the audio input interface 23 (the part of the audio input interface 23 exposed outside the housing 10) is formed in the housing body 11, and the relief groove 111 is communicated with the first relief hole. The audio input interface 23 which penetrates out from the first relief hole can be accommodated in the relief groove 111.

In the present embodiment, the first relief hole is formed in the bottom wall of the housing body 11, and the relief groove 111 is formed by recessing the bottom wall from the bottom surface to the top surface to make the exposed part of the audio input interface 23 accommodated in the wall surface of the lower side face of the housing body 11.

In some other optional embodiments, the relief groove 111 may also be formed in other walls of the housing body 11, or in two mutually connected walls of the housing body 11. The first relief hole may also be formed in other walls of the housing body 11.

In some embodiments, the power input interface 25 and/or the power output interface 26 may be arranged as a convex connector used for plugging, or as a concave interface used for receiving a plug.

It should be understood that the power input interface 25 and/or the power output interface 26 can be arranged as an existing form of interface, such as a Micro USB interface, a USB Type C interface and a Lightning interface, etc.

In the present embodiment, the power input interface 25 is a concave interface used for receiving a plug, and the power output interface 26 is a convex connector used for plugging.

In some embodiments, the wireless earphone adapter device 1 can be applied to any form of existing wireless earphones such as Bluetooth wireless earphones, infrared wireless earphones and meter wave wireless earphones. The wireless communication module can be correspondingly arranged as an existing wireless communication module that is adapted to the wireless earphones.

In the present embodiment, the wireless communication module is a Bluetooth module.

In some embodiments, the adapter component 20 may also comprise a trigger module 27 and a switch module (not shown in the figure). The trigger module 27 is electrically connected with the control unit and configured to generate a first trigger signal and to transmit the first trigger signal to the control unit when the audio input interface 23 is accommodated in the relief groove 111, and to generate a second trigger signal and transmitting the second trigger signal to the control unit when the audio input interface 23 is located outside the relief groove 111.

The switch module is electrically connected with the control unit and the wireless communication module and configured to control the wireless communication module to switch off when the control unit receives the first trigger signal, and to control the wireless communication module to switch on when the control unit receives the second trigger signal. The wireless communication module can be switched on synchronously when the audio input interface 23 is taken out from the relief groove 111 (which may be used for connecting the audio input interface 23 with audio equipment).

When the audio input interface 23 is electrically connected with the audio equipment, audio transmission between the audio equipment and a wireless earphone can be realized without the need of manually switching on the wireless communication module. When the audio input interface 23 is placed in the relief groove 111, the wireless communication module is switched off synchronously. The wireless communication module does not need to be switched off manually, which reduces user operation, improves user experience, and avoids the phenomenon of power waste caused by a user forgetting to switch off the wireless communication module.

Referring to FIG. 3 and FIG. 4 together, in the present embodiment, the trigger module 27 is a spring type trigger switch. A first switch hole 113 is formed in the housing body 11, and the trigger module 27 penetrates into the first switch hole 113. The first switch hole 113 is located in a wall of the housing body 11 defining the relief groove 111, so as to enable the audio input interface 23 to be abutted against the trigger module 27 when the audio input interface 23 is accommodated in the relief groove 111, and enable the trigger module 27 to be triggered, thus to generate the first trigger signal. When the audio input interface 23 is taken out from the relief groove 111, the audio input interface 23 is separated from the trigger module 27, and the spring type trigger module 27 bounds back to an initial state automatically, thus to generate the second trigger signal.

Specifically, the first switch hole 113 is arranged at a position which enables the transmission connector 232 of the audio input interface 23 to be abutted against the trigger module 27 when the audio input interface 23 is located in the relief groove 111.

In some other optional embodiments, the first switch hole 113 may also be formed in other positions and may also be abutted against the transmission line 231. It should be understood that the arrangement position of the trigger module 27 needs to enable the audio input interface 23 to be abutted against the trigger module 27 when the audio input interface 23 is located in the relief groove 111, and enable the trigger module 27 to be triggered.

In some other optional embodiments, the trigger module 27 may not be a spring type trigger switch, but may be an inductive trigger switch (such as a contact sensor and a photoelectric induction switch). The selection of the triggering mode of the trigger module 27 needs to satisfy that a first trigger signal is generated by the trigger module 27 and transmitted to the control unit when the audio input interface 23 is located in the relief groove 111, and a second trigger signal is generated by the trigger module 27 and transmitted to the control unit when the audio input interface 23 is located outside the relief groove 111.

In the present embodiment, the switch module is arranged on the plate body 22, and is arranged on the second surface of the plate body 22.

In some other optional embodiments, the switch module may also be arranged on the first surface.

In some other optional embodiments, the power input interface 25 and/or the audio input interface 23 and/or the power output interface 26 and/or the control unit and/or the wireless communication module and/or the switch module may also be arranged separately (not arranged on the plate body 22) and electrically connected with other elements/units/modules arranged on the plate body 22 by cables, etc.

In some other optional embodiments, the trigger module may also be omitted, and only the switch module is provided. In this case, the switch module can be arranged as a mechanical switch module used for controlling the on-off of a circuit, and the switch module is manually controlled by a user to control the on-off of the circuit, thus to realize the control of the wireless communication module. In this case the switch module needs to be arranged on the housing 10 to facilitate the user in controlling the switch module.

Alternatively, the switch module can be arranged as a sensing switch module which is triggered by sensing a user's touch, etc., thus to realize the control of the switch of the wireless communication module through the control unit. In this case, the switch module can be arranged on the housing 10 or in the housing 10.

As shown in FIG. 4, in some embodiments, the adapter component 20 also comprises an indication module 28 which is electrically connected with the control unit and configured to indicate a charging state when the power input interface 25 is electrically connected with the power adapter.

In the present embodiment, the indication module 28 is a 90° lamp, which is arranged on the second surface of the plate body 22 and located at one end of the plate body 22 close to the power input interface 25. A luminous direction of the indication module 28 is toward an extension direction of the power input interface 25 (i.e., the luminous direction forms a 90° angle with the arrangement direction of the indication module 28). The housing body 11 is provided with an indication hole 114 at a corresponding position, configured to show the indication module 28 to indicate that it is now in the charging state.

In some other optional embodiments, the indication module 28 can be arranged as a light guide column, etc.

In some embodiments, the adapter component 20 also comprises an adapter housing 21, the plate body 22, the control unit, the wireless communication module, the switch module and the battery 24 are arranged in the adapter housing 21, and the audio input interface 23, the power input interface 25 and the power output interface 26 penetrate through the adapter housing 21, respectively. The trigger module 27 is also arranged on the adapter housing 21.

In the present embodiment, the plate body 22 is arranged horizontally in the adapter housing 21, and the axes of the two are parallel in a longitudinal direction. The outer contour of the plate body 22 is adapted to the inner contour of the adapter housing 21. A second switch hole 2111, an indication groove 2112, a penetrating hole 2121, a second relief hole 2113 and a second charging hole 213 are formed in the adapter housing 21. The penetrating hole 2121 is formed in an upper side face of the adapter housing 21 and configured for the power output interface 26 to penetrate into the receiving space 13. The second relief hole 2113 is corresponding to the first relief hole and is configured for the audio input interface 23 to penetrate out. The second charging hole 213 is corresponding to the first charging hole 112 and is configured for the power input interface 25 to penetrate. The indication groove 2112 is corresponding to the indication hole 114 and is configured to show the indication module 28. The second switch hole 2111 is configured for realizing electrical connection between the trigger module 27 and the control unit (a cable for the electrical connection between the two penetrate into the second switch hole 2111).

The adapter housing 21 is configured to accommodate each module/unit/element, thereby serving as a protective cover for each module/unit/element. This design helps avoid pollution and damage caused by collision, dust, etc. that may occur during storage in the charging case or long-term use. Consequently, the adapter housing 21 extends the service life of the wireless earphone adapter device 1.

Specifically, the adapter housing 21 is arranged lengthwise and is arranged in the housing body 11 on the bottom end. A horizontal section of the adapter housing 21 is roughly in a racetrack-shaped and is adapted to a horizontal section of the housing 10. This design can maximize the volume in the adapter housing 21, fix the position of the adapter housing 21 in the housing body 11 and avoid relative shaking.

In some embodiments, at least one limiting member used for limiting the position of the adapter housing 21 can be arranged in the housing body 11.

In some embodiments, the adapter housing 21 comprises a first part 211 and a second part 212. An opening is formed in the first part 211, and the second part 212 is covered on the opening to realize accommodation of each component.

In the present embodiment, the second part 212 is in a plate shape, the first part 211 is configured as a hollow body with an upper side opened. Each module/unit/element is placed in the first part 211, and the second part 212 is covered above. The penetrating hole 2121 is formed in the second part 212. The first part 211 and the second part 212 are arranged lengthwise. The top side face of one end of the first part 211 is recessed downward to form a charging groove; when the second part 212 is covered on the first part 211, the opening of the charging groove is sealed by one end of the first part 211 to form the second charging hole 213. The second relief hole 2113 is formed in the bottom wall of the first part 211. The indication groove 2112 is communicated with the second charging hole 213, and is formed by recessing downward along the bottom wall of the second charging hole 213.

The second switch hole 2111 is formed in the bottom wall of the first part 211. The second switch hole 2111 and the second relief hole 2113 are formed in both ends of the bottom wall of the first part 211, respectively. The bottom wall of a peripheral edge of the second switch hole 2111 is provided with a plugging bulge, an assembly hole is also formed in the trigger module 27. The trigger module 27 and the bottom wall of the first part 211 are fixed with each other through interference fit between the plugging bulge and the assembly hole.

It should be understood that the second switch hole 2111 may not be arranged correspondingly to the first switch hole 113, and the purpose of arranging the second switch hole 2111 is to realize the electrical connection between the trigger module 27 and the control unit, so it is only necessary to realize this purpose.

Therefore, in some other optional embodiments, the second switch hole 2111 may also be arranged at other positions on the first part 211, the trigger module 27 is fixed at a position corresponding to the first switch hole 113 on the first part 211. In this case, the trigger module 27 realizes electrical connection with the control unit by setting cable penetrates into the second switch hole 2111.

In some other optional embodiments, the second charging hole 213 may also be separately formed in the first part 211. The second relief hole 2113 may also be formed by connecting two grooves formed by the first part 211 and the second part 212, respectively. The indication groove 2112 may also be arranged as a hole.

In some other optional embodiments, the trigger module 27 and the first part 211 may also be fixed with each other in the forms of bonding, welding, arranging the limiting member, etc. Alternatively, the trigger module 27 may also penetrate into the second switch hole 2111, etc.

In some other optional embodiments, the opening of the first part 211 may also be formed in positions other than the upper side. In this case, the arrangement positions of the penetrating hole 2121, the second charging hole 213 and the second relief hole 2113 can be adjusted accordingly. It should be understood that the position arrangement of the penetrating hole 2121 needs to ensure that the power output interface 26 can be electrically connected with the charging port of the charging case when penetrating into the penetrating hole 2121.

It should be understood that the first part 211 and the second part 212 can be arranged integrally in one piece, detachably connected, rotationally connected or fixed with each other.

In the present embodiment, the first part 211 and the second part 212 are arranged by snap-riveting.

In the present embodiment, in order to ensure the miniaturization of the Bluetooth wireless earphone adapter device 1, the distance between the first surface of the plate body 22 and an adjacent inner wall of the second part 212 is 2.3 mm, so as to avoid excessive space while ensuring a space for arranging components and parts. The height limit of the second surface of the plate body 22 is 1.4 mm (i.e., the distance between the second surface of the plate body 22 and the battery 24 is 1.4 mm), and no component or part is arranged on the second surface as far as possible. This design can ensure the miniaturization of the wireless earphone adapter device 1.

In some embodiments, the adapter component 20 also comprises a protective member 29 which is arranged between the first relief hole and the second relief hole 2113 and is configured to protect the audio input interface 23 penetrating here. This design can avoid damage to a bend part caused by repeated bending of the audio input interface 23 at this position when taken out from the relief groove 111 or being accommodated in the relief groove 111 during long-term use.

In some other optional embodiments, the audio input interface 23 can also be protected by changing the shape (e.g., into a circular arc shape) of the housing body 11 (and/or the adapter housing 21) at the first relief hole (and/or the second relief hole 2113), without the need of arranging the protective member 29.

It should be understood that the control unit, the audio input interface 23, the wireless communication module, the battery 24, the power input interface 25, the power output interface 26, the trigger module 27, the indication module 28, the switch module and the indication module 28 can adopt the prior art to achieve the above effect, which will not be limited specifically herein.

It can be understood that the above embodiments only express the preferred embodiments of the application, and are described more specifically in details, but shall not be consequently interpreted as a limitation to the scope of the patent for the application. It should be noted that, for those ordinary skilled in the art, above technical features can be combined freely, several deformations and improvements can also be made without departing from the concept of the application, all of which belong to the protection scope of the application. Therefore, any equivalent transformation and modification made in accordance with the scope of claims of the application shall belong to the scope of claims of the application.

What is claimed is:

1. A wireless earphone adapter device, comprising an adapter component (20), wherein the adapter component (20) comprises:
a control unit;
an audio input interface (23) electrically connected with the control unit and configured to receive audio signals when an audio equipment is connected;
a wireless communication module electrically connected to the control unit and configured to transmit the audio signals converted into wireless signals to a wireless earphone;
a battery (24) electrically connected with the control unit;
a power input interface (25) electrically connected with a power adapter and configured to obtain power from the power adapter and charging the battery (24); and
a power output interface (26) electrically connected to the power input interface (25) and configured to transmit a voltage of the power input interface (25) to a charging case of the wireless earphone for power supply.

2. The wireless earphone adapter device according to claim 1, wherein the device also comprises a housing body (11), the adapter component (20) is arranged in the housing body (11) and is arranged at the bottom end of the housing body (11), a receiving space (13) configured to receive the charging case is formed above the adapter component (20), and the power output interface (26) extends partially into the receiving space (13).

3. The wireless earphone adapter device according to claim 2, wherein the adapter component (20) comprises a plate body (22), the control unit, the wireless communication module, the power input interface (25) and the power output interface (26) are arranged on the plate body (22), the power output interface (26) is erected on a face of the plate body (22) close to the receiving space (13), and the battery (24) is arranged on a side of the plate body (22) away from the receiving space (13).

4. The wireless earphone adapter device according to claim 2, wherein the device also comprises a cover (12), an opening communicating the receiving space (13) with the outside is formed in the housing body (11), and the cover (12) is configured to close the opening.

5. The wireless earphone adapter device according to claim 4, wherein the opening is located at the top end of the housing body (11), and the cover (12) is fitted onto a cover body of the charging case.

6. The wireless earphone adapter device according to claim 2, wherein a first relief hole configured for the audio input interface (23) to penetrate is formed in the housing body (11), an outer wall surface of the housing body (11) is recessed inward to form a relief groove (111) for accommodating the audio input interface (23), and the relief groove (111) is communicated with the first relief hole.

7. The wireless earphone adapter device according to claim 6, wherein the adapter component (20) also comprises a trigger module (27) electrically connected with the control unit, and the trigger module (27) is configured to generate a first trigger signal and to transmit the first trigger signal to the control unit when the audio input interface (23) is accommodated in the relief groove (111), and to generate a second trigger signal and transmit the second trigger signal to the control unit when the audio input interface (23) is located outside the relief groove (111);
the adapter component (20) also comprises a switch module electrically connected with the control unit and the wireless communication module, and the switch module is configured to control the wireless communication module to switch off when the control unit receives the first trigger signal, and to control the wireless communication module to switch on when the control unit receives the second trigger signal.

8. The wireless earphone adapter device according to claim 7, wherein a first switch hole (113) is also formed in a wall defining the relief groove (111), and the trigger module (27) penetrates into the first switch hole (113), so as to enable the audio input interface (23) to be abutted against the trigger module (27) when the audio input interface (23) is accommodated in the relief groove (111).

9. The wireless earphone adapter device according to claim 1, wherein the adapter component (20) also comprises an adapter housing (21), the control unit, the wireless communication module and the battery (24) are arranged in the adapter housing (21), and the audio input interface (23), the power input interface (25) and the power output interface (26) penetrate through the adapter housing (21), respectively.

10. The wireless earphone adapter device according to claim 1, wherein the audio input interface (23) comprises a transmission line (231) and a transmission connector (232) arranged on one end of the transmission line (231), and the other end of the transmission line (231) is electrically connected with the control unit.
